(19) United States
(12) Patent Application Publication
(10) Pub. No.: US 2022/0381896 A1
(43) Pub. Date: Dec. 1, 2022

(54) PASSENGER PRESENCE DETECTION SYSTEM FOR A BUS AND RELATED METHODS

(71) Applicant: VOXX INTERNATIONAL CORPORATION, Hauppauge, NY (US)

(72) Inventors: JOSEPH A. SANTAVICCA, AUBURN HILLS, MI (US); MIKE MORALES, ORLANDO, FL (US)

(21) Appl. No.: 17/330,531

(22) Filed: May 26, 2021

(51) Int. Cl. G01S 13/56; B60Q 9/00

(52) U.S. Cl. CPC G01S 13/56; B60Q 9/00

(57) ABSTRACT

A passenger presence detection system may include radar detectors arranged in spaced relation and directed toward a plurality of rows of passenger seats in a bus. Each radar detector may include a radar transmitter(s), radar receiver(s), and a radar processor cooperating with the radar transmitter(s) and radar receiver(s) to determine passenger presence data based upon a first movement threshold having a first determination time and a second movement threshold having a second determination time. The first movement threshold may be smaller than the second movement threshold and being capable of detecting movement less than 5 millimeters (for example) which is indicative of at least one of passenger respiration and passenger heartbeat, and the first determination time may be larger than the second determination time. The system may further include a controller configured to generate a passenger presence indication based upon the passenger presence data.

### FIELD OF THE INVENTION

The invention relates to detection systems and methods, and, more particularly to a detection system and related method for a vehicle, such as a bus.

### BACKGROUND

Unfortunately, instances of people or animals being left behind in a vehicle are not uncommon. As a result, various systems have been developed to help avoid such events. One such helpful system is set forth in U.S. Pat. No. 10,818,155 to Staninger et al., which is hereby incorporated herein in its entirety by reference, discloses a radar detection device for detecting a being left within a vehicle which includes a sensor that detects when a being (e.g. a pet, a child, etc.) is within the vehicle and the operator of the vehicle has moved away from the vehicle by more than, for example, five feet. Upon such detection, the device emits a sound to notify others nearby of the being that was left within the vehicle. Determination that the operator has left the vehicle may be by a loss of a signal from a personal transmitter that is attached to the operator's key ring or worn by the operator. After moving away from the vehicle by more than five feet, the signal from the personal transmitter decreases and initiates a determination as to whether a being remains within the vehicle.

Despite the existence of such systems, further developments in passenger presence detection systems may be desirable for certain vehicle applications.

### SUMMARY

A passenger presence detection system is provided for a bus including a plurality of rows of passenger seats. The passenger detection system may include a plurality of radar detectors arranged in spaced relation and directed toward the plurality of rows of passenger seats. Each radar detector may include at least one radar transmitter, at least one radar receiver, and a radar processor cooperating with the at least one radar transmitter and at least one radar receiver to determine passenger presence data based upon a first movement threshold having a first determination time and a second movement threshold having a second determination time. The first movement threshold may be smaller than the second movement threshold and being capable of detecting movement less than 5 millimeters, for example, which is indicative of at least one of passenger respiration and passenger heartbeat, and the first determination time may be larger than the second determination time. The system may further include a controller configured to generate a passenger presence indication based upon the passenger presence data.

In an example embodiment, adjacent ones of the plurality of radar detectors may be configured to have overlapping fields of view, and the controller may be configured to generate the passenger presence indication based upon passenger presence data from radar detectors having overlapping fields of view. More particularly, the controller may be configured to generate the passenger presence indication based upon a voting algorithm applied to the passenger presence data from the radar detectors having overlapping fields of view.

In one example implementation, the controller may be configured to generate a map of the plurality of rows of passenger seats and any passengers therein based upon the passenger presence data. Furthermore, the bus may have a passenger access door, and the system may further include a passenger access door sensor arrangement. Moreover, the controller may be configured to generate the passenger presence indication further based upon the passenger access door sensor arrangement. In some embodiments, the system may further include a bus position determining device, and the controller may be configured to cooperate with the bus position determining device to provide a bus position indication.

In an example embodiment, the system may include a wireless transceiver, such as a cellular transceiver, and the controller may be configured to cooperate with the wireless transceiver to provide the passenger presence indication to a remote device. The bus may comprise a driver position, and the system may further include a driver interface at the driver position and coupled to the controller. More particularly, the driver interface may include a display and at least one input device.

In one example embodiment, the bus may comprise a wired communications network therein, and the plurality of radar detectors and controller may communicate via the wired communications network. In another example embodiment, the bus may comprise a wireless communications network therein, and the plurality of radar detectors and controller may communicate via the wireless communications network. In addition, the bus may have a passenger access aisle extending through the plurality of rows of passenger seats, and the plurality of radar detectors may be arranged in spaced relation above the passenger access aisle, for example.

A related method for passenger presence detection in a bus including a plurality of rows of passenger seats is also provided. The method may include operating a plurality of radar detectors arranged in spaced relation and directed toward the plurality of rows of passenger seats. Each radar detector may include at least one radar transmitter, at least one radar receiver, and a radar processor cooperating with the at least one radar transmitter and at least one radar receiver to determine passenger presence data based upon a first movement threshold having a first determination time and a second movement threshold having a second determination time. The first movement threshold may be smaller than the second movement threshold and be capable of detecting movement less than 5 millimeters, with the first determination time being larger than the second determination time. The method may further include operating a controller to generate a passenger presence indication based upon the passenger presence data.

### BRIEF DESCRIPTION OF THE DRAWINGS

FIG. 1 is a schematic diagram of a passenger presence detection system for a bus in accordance with an example embodiment.

FIG. 2 is a schematic block diagram of an example implementation of the passenger presence detection system of FIG. 1.

FIG. 3 is a schematic block diagram illustrating example components which may be used in the passenger presence detection system of FIG. 1.

FIG. 4 is a schematic diagram illustrating an example implementation of the system of FIG. 1 providing passenger presence indications via a wireless network.

FIG. 5 is a flow diagram illustrating method aspects associated with the system of FIG. 1.

### DETAILED DESCRIPTION

Example embodiments will now be described more fully hereinafter with reference to the accompanying drawings, in which the example embodiments are shown. The embodiments may, however, be implemented in many different forms and should not be construed as limited to the specific examples set forth herein. Rather, these embodiments are provided so that this disclosure will be thorough and complete. Like numbers refer to like elements throughout.

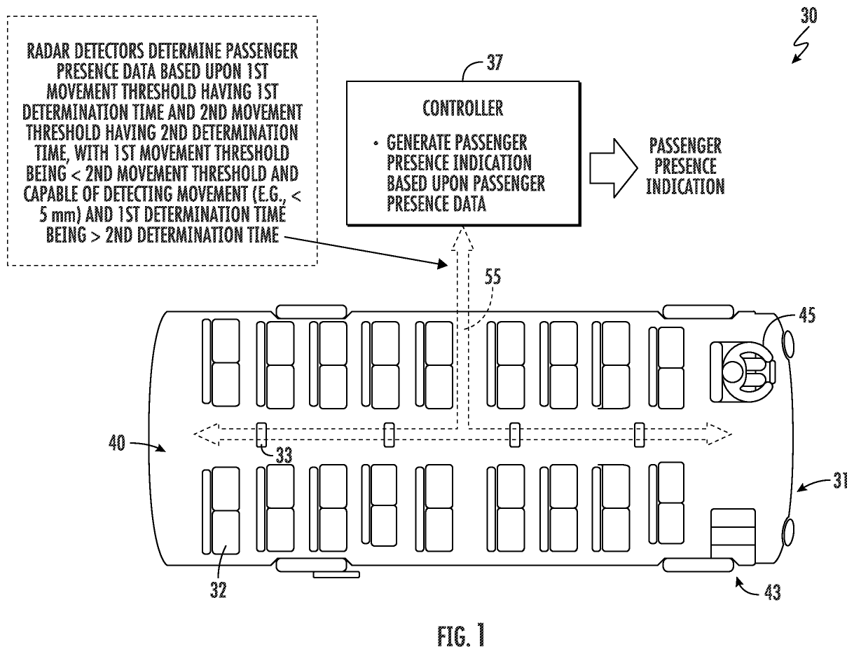

Referring initially to FIGS. 1-3, a passenger presence detection system 30 for a bus 31 is first described. The bus 31 illustratively includes a plurality of rows of passenger seats 32. The passenger detection system 30 illustratively includes a plurality of radar detectors 33 arranged in spaced relation and directed toward the plurality of rows of passenger seats 32.

Each radar detector illustratively includes one or more radar transmitters (TX) 34, one or more radar receivers (RX) 35, and a radar processor 36. The radar processor 36 is configured to cooperate with the radar transmitter 34 and radar receiver 35 to determine passenger presence data, that is, to detect the presence of living beings within the bus 31 based upon detected movement. As the radar transmitters 34 direct RF signals towards the seats 32, the radar processor 36 monitors reflected signals received by the radar receivers 35 and generates the passenger presence data based upon a first movement threshold having a first determination time, and a second movement threshold having a second determination time. In an example embodiment, the first movement threshold may be smaller than the second movement threshold and may further be capable of detecting movement of less than 5 millimeters. This slight movement threshold is indicative of passenger respiration and/or a passenger heartbeat. Other thresholds are also possible as will be appreciated by those skilled in the art. Moreover, the first determination time is larger than the second determination time. The system 30 further illustratively includes a controller 37 configured to generate a passenger presence indication based upon the passenger presence data, as will be discussed further below.

More particularly, the above-noted thresholds and determination times correspond to two basic detection classes. The first is a body movement class. Body movement usually happens quickly, and the radar detector 33 will typically be able to detect and report the results of detected body movement within a time frame of 1-2 seconds, for example. Movements may include major movements, such as walking, arm waving, etc. Minor movements may include body shifting, slight hand or head motions, etc.

The second detection class is for breathing/heartbeats. Because they involve such slight movements, they generally are not detectable in a short time frame such as arm/leg movement. Rather, these subtle movements (e.g., less than 5 millimeters) are detected over time, typically requiring a duration of 20-40 seconds, for example, by the radar detectors 33 to detect and report breathing or a heartbeat. The radar processor 36 may run an algorithm designed to detect each of the two classes with separate tuning and threshold limits per class as described above, although other thresholds and time limits may be used in different embodiments. That is, for the radar processor 36 to report body movement, the detected response has to be over a major movement threshold, as discussed above, but may be reported quickly in just a few seconds. However, to report passenger presence based upon breathing/heartbeats, the threshold limit is typically much smaller (just a few millimeters) but it has to be verified over the longer duration. This may significantly help to reduce the likelihood of false positive and negative cases.

One example implementation of the radar detector 33 is the SC1233AR3 24 GHz RADAR Sensor from Socionext America Inc. This is an all-in-one 24 GHz radar sensor that enables entry motion and distance detection. The sensor also performs angle detection with light microcontroller calculations. A detection area example for this sensor is greater than 8 m² in the front direction with a 120 degree field of view (FOV). Moreover, it uses two receiver antennas capable of 2D angle detection. However, it should be noted that other radar sensors may be used in different embodiments. For example, radar sensors operating at different frequencies may be used, such as operating at 60 GHz.

Various calibration parameters may be used in the setup up the system 30, which are configurable on a per-implementation basis. The first is motion threshold, which determines the detection based on the magnitude of motion. Generally speaking, the larger the value, the smaller the motion that would be ignored by the radar processor 36. Another parameter is distance, and in an example embodiment upper and lower distance boundaries may be set. Still another parameter is receiver gain, which in an example embodiment may be set for high, medium, or low. Higher gain would allow further objects to be detected, but can also cause false positives.

Yet another calibration parameter is intervals, which determines the interval or time between sensing frames. Generally speaking, longer intervals result in less scanning per unit of time, and therefore less battery drain when the vehicle is off. Chirp time configures the frequency sweep duration of the sensing operation (e.g., in milliseconds). A longer duration may improve the performance of detection of farther objects. A high pass filter parameter may be set to first or second order in an example embodiment. The first order may be suitable for detecting a human standing one meter away, whereas the second order would perform better around five to ten meters away. Additionally, a respiration/heart dwell time allows for the setting of the time to count peak and valley cycles (responsiveness vs. accuracy). As noted above, this may be in a 20 to 40 second range in an example embodiment, although other durations may be used in different embodiments.

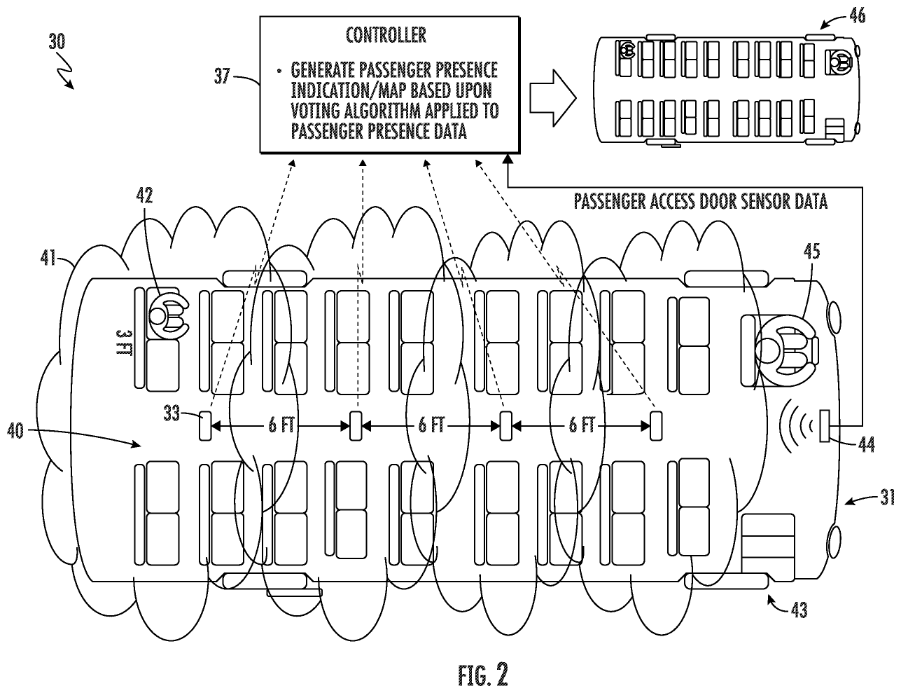

In the example implementation shown in FIG. 2, the dimensions of the bus 31 are twenty-five feet long, and ninety-one inches wide. Furthermore, a passenger access aisle 40 extends through the rows of passenger seats 32, and four radar detectors 33 are arranged in spaced relation (six feet apart in the illustrated example) above the passenger access aisle. With this spacing, adjacent ones of the radar detectors 33 are configured to have overlapping fields of view 41 (illustrated as clouds in FIG. 2). In this configuration, the controller 37 may generate the passenger presence indication based upon a voting or consensus algorithm applied to the passenger presence data from the radar detectors 33 having overlapping fields of view. Example consensus algorithms may include Raft and Paxos algorithms, although other suitable approaches may be used in different embodiments. Such approaches may be applied to reach a consensus from adjacent radar detectors 33 of passenger presence, which can help boost a confidence in the determination. The passenger presence indication may be provided locally at the bus by any of a number of audible, visual, or combination indications. For example, horn operation, window operation, flashing lights, an audible alert, etc. may be used for a local passenger presence indication. Exemplary remote passenger presence indications are described in great detail below.

However, a consensus of multiple radar detectors 33 need not be present in all cases to have a positive passenger determination. In the illustrated example, a passenger 42 remains in a seat 32 in the last row of the bus, which is only within the field of view of the last radar detector 33 in the aisle, but a positive passenger presence may still be reported based solely on the single radar detector. Generally speaking, the fields of view 41 of the radar detectors 33 (as well as the number of radar detectors) may be selected or adjusted to overlap as desired to leverage the enhanced confidence factor of a consensus algorithm, yet while being mindful of reaching too far and thereby risking false positive detections from movement outside of the bus 31.

The bus 31 illustratively includes a passenger access door 43, and in the illustrated example the system 30 further includes an arrangement of one or more passenger access door sensors 44 positioned adjacent the passenger access door. By way of example, such sensors may include motion sensors, photoelectric beam sensors, passive infrared (IR), radar sensors, etc. The data provided by the motion sensor(s) 44 provides the controller 37 with passenger access door sensor data and another point of reference for determining passenger presence on the bus 31, in addition to the presence of a bus driver 45. For example, the controller 37 may count a number of passengers entering or exiting the bus 31, and compare the returns from the radar detectors 33 to the expected count. The passenger presence indication may accordingly further be based upon the passenger access door sensor(s) 44, in that it may provide an additional confidence factor for reporting passenger presence, or generation of the passenger presence indication may be limited to times when the driver 45 is no longer on the bus 31, for example.

Also in the illustrated example, the controller 37 is configured to generate a map 46 of the rows of passenger seats 32 and any passengers 42 therein based upon the passenger presence data, as shown. Here the map 46 takes the form of a plan view of the bus 31 with responsive icons showing the presence of the driver 45 and passenger 42 in the last row of seats 32. However, other map formats or layouts may be used in different embodiments.

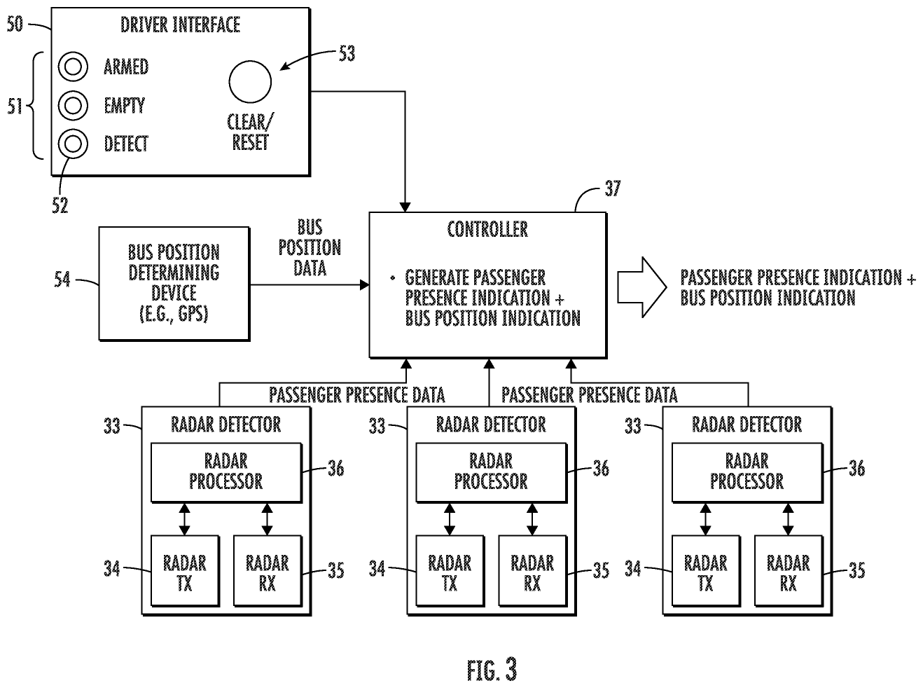

In the example of FIG. 3, the system 30 further illustratively includes a driver interface 50 at the driver position of the bus 31 which is coupled to the controller 37. In the present example, the driver interface 50 illustratively includes a display 51 (here an array of status lights 52) and an input device 52 (here a reset button). In the present example, the display 51 includes status lights 52 for indicating that the system 30 is armed, and whether the system has detected that the bus is empty of passengers or that a passenger presence has been detected. However, it will be appreciated that other types of displays (e.g., a display screen) and input devices (e.g., keyboard, etc.) may also be used in different configurations where further input and/or information display capabilities are desired, such as for displaying the map 46 discussed above.

In the example of FIG. 3, the system 30 further illustratively includes a bus position determining device 54 (e.g., GPS), and the controller 37 may be configured to cooperate with the bus position determining device to provide a bus position indication in addition to the passenger presence indication. This may be helpful in school bus applications, for example, particularly when busses get parked far away from buildings during field trips or during down times between routes. Including bus position information along with the passenger presence indication may advantageously allow administrators to quickly locate where a bus in question is parked responsive to a passenger presence detection.

Various mediums may be used for communications between the radar detectors 33 and the controller 37. In the example shown in FIG. 1, a wired communications network 55 extends throughout the bus, e.g., a vehicle data bus over which vehicles communicate based upon a vehicle bus protocol such as Controller Area Network (CAN), Local Interconnect Network (LIN), etc. In the example shown in FIG. 2, the radar detectors 33 and the controller 37 communicate via a wireless communications network (e.g., Wi-Fi, Bluetooth, etc.).

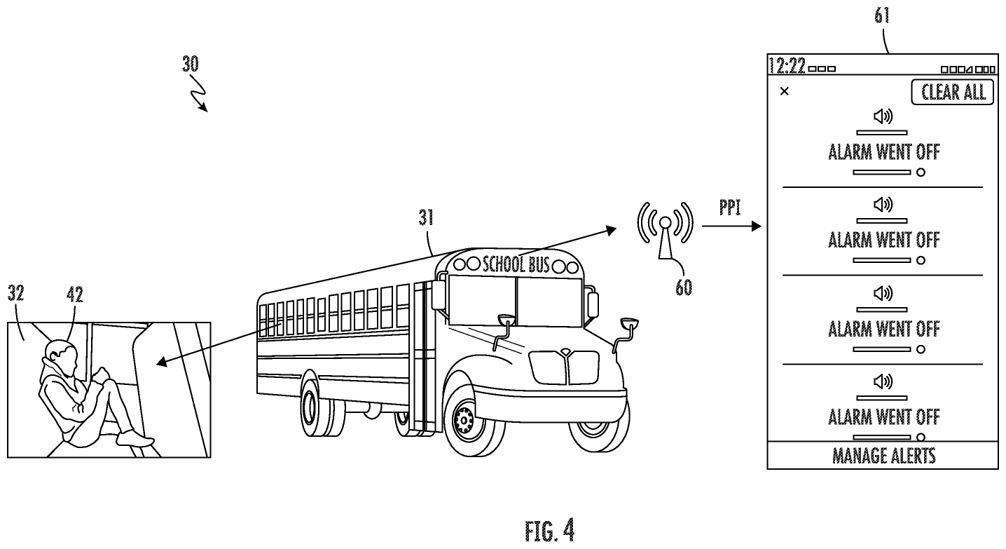

Referring additionally to FIG. 4, in some implementations the system 30 may further include a wireless transceiver, such as a cellular transceiver 60 carried by the bus 31. The controller 37 may be configured to cooperate with the cellular transceiver 60 to provide the passenger presence indication (PPI) to a remote device, such as a server or in the illustrated example to a mobile wireless device 61 (e.g., smartphone, tablet, etc.) of a driver or administrator. In the present example, an app running on the mobile wireless device 61 informs the user when a passenger presence indication has occurred, here by displaying that the “alarm went off”. As noted above, such notifications may include other data, such as the location of the bus 31 from the bus position determining device 54, the map 46, environmental conditions on the bus (e.g., internal temperature from an onboard thermometer), etc. It should be noted that the passenger presence indication may be provided through the cellular transceiver 60 in other ways as well, such as email messages, text messages, etc.

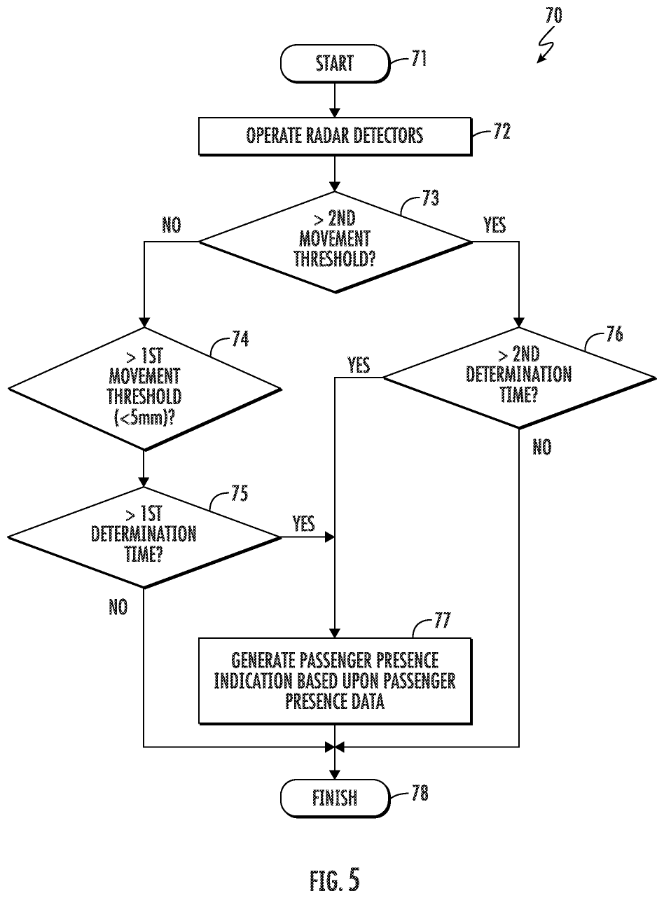

Referring additionally to the flow diagram 70 of FIG. 5, a related method for passenger presence detection in the bus 31 is now described. Beginning at Block 71, the plurality of radar detectors 33 are operated (Block 72) to determine passenger presence data based upon a first movement threshold (Block 74) having a first determination time (Block 75) and a second movement threshold (Block 73) having a second determination time (Block 76). The first movement threshold may be smaller than the second movement threshold and be capable of detecting movement less than 5 millimeters, for example, which is indicative of at least one of passenger respiration and passenger heartbeat, with the first determination time being larger than the second determination time, as discussed further above. The method further illustratively includes operating the controller 37 to generate a passenger presence indication based upon the passenger presence data from the radar detectors 33, at Block 77. The method of FIG. 5 illustratively concludes at Block 78.

The approach set forth herein advantageously allows for extremely sensitive movement detections, including heartbeats and breathing, which may be important in the case of sleeping children or animals. Furthermore, this approach allows for enhanced classification of movement to recognize major and minor body movements, as well as subtle movements associated with breathing and respiration, to provide less cases of false positives and negatives. Moreover, range information may also be provided from measured distance/limit detection within the bus 31, and the sensors 33 may advantageously be hidden or otherwise mounted in a non-obtrusive fashion inside other devices within the interior of the bus 31 if desired. The radar detectors 33 may advantageously avoid the need for recalibration, lenses, and are relatively resistant to dust to thereby provide a long lifetime of operation. Moreover, the radar detectors 33 may advantageously “see” through material such as clothes and blankets, yet are not cameras and therefore provide for non-invasive operation that is respectful of passenger privacy concerns.

In other embodiments, the passenger detection system may be used in other vehicles, such as a train or airplane, for example, as these vehicles also include passenger access aisles. Of course, various components and features described herein may also be used in passenger vehicles (cars and trucks) as well, as will be appreciated by those skilled in the art. Accordingly, many modifications and other embodiments will come to the mind of one skilled in the art having the benefit of the teachings presented in the foregoing descriptions and the associated drawings. Therefore, it is understood that the foregoing is not to be limited to the example embodiments, and that modifications and other embodiments are intended to be included within the scope of the appended claims.

That which is claimed is:

1. A passenger presence detection system for a bus comprising a plurality of rows of passenger seats, the passenger presence detection system comprising:
a plurality of radar detectors arranged in spaced relation and directed toward the plurality of rows of passenger seats, each radar detector comprising
at least one radar transmitter,
at least one radar receiver, and
a radar processor cooperating with the at least one radar transmitter and at least one radar receiver to determine passenger presence data based upon a first movement threshold having a first determination time and a second movement threshold having a second determination time, the first movement threshold being smaller than the second movement threshold, and the first determination time being larger than the second determination time; and
a controller configured to generate a passenger presence indication based upon the passenger presence data.

2. The passenger presence detection system of claim 1 wherein the radar detectors are capable of detecting movement less than 5 millimeters which is indicative of at least one of passenger respiration and passenger heartbeat.

3. The passenger presence detection system of claim 1 wherein adjacent ones of the plurality of radar detectors are configured to have overlapping fields of view; and wherein the controller is configured to generate the passenger presence indication based upon passenger presence data from radar detectors having overlapping fields of view.

4. The passenger presence detection system of claim 3 wherein the controller is configured to generate the passenger presence indication based upon a voting algorithm applied to the passenger presence data from the radar detectors having overlapping fields of view.

5. The passenger presence detection system of claim 1 wherein the controller is configured to generate a map of the plurality of rows of passenger seats and any passengers therein based upon the passenger presence data.

6. The passenger presence detection system of claim 1 wherein the bus has a passenger access door; and comprising a passenger access door sensor arrangement; and wherein the controller is configured to generate the passenger presence indication further based upon the passenger access door sensor arrangement.

7. The passenger presence detection system of claim 1 comprising a bus position determining device; and wherein the controller is configured to cooperate with the bus position determining device to provide a bus position indication.

8. The passenger presence detection system of claim 1 comprising a wireless transceiver; and wherein the controller is configured to cooperate with the wireless transceiver to provide the passenger presence indication to a remote device.

9. The passenger presence detection system of claim 1 wherein the bus comprises a driver position; and comprising a driver interface at the driver position and coupled to the controller.

10. The passenger presence detection system of claim 9 wherein the driver interface comprises a display and at least one input device.

11. The passenger presence detection system of claim 1 wherein the bus comprises a wired communications network therein; and wherein the plurality of radar detectors and controller communicate via the wired communications network.

12. The passenger presence detection system of claim 1 wherein the bus comprises a wireless communications network therein; and wherein the plurality of radar detectors and controller communicate via the wireless communications network.

13. The passenger presence detection system of claim 1 wherein the bus has a passenger access aisle extending through the plurality of rows of passenger seats; and wherein the plurality of radar detectors are arranged in spaced relation above the passenger access aisle.

14. A passenger presence detection system for a bus comprising a plurality of rows of passenger seats, the passenger presence detection system comprising:
a plurality of radar detectors arranged in spaced relation and directed toward the plurality of rows of passenger seats, adjacent ones of the plurality of radar detectors being configured to have overlapping fields of view, each radar detector comprising
at least one radar transmitter,
at least one radar receiver, and
a radar processor cooperating with the at least one radar transmitter and at least one radar receiver to determine passenger presence data based upon a first movement threshold having a first determination time and a second movement threshold having a second determination time, the first movement threshold being smaller than the second movement threshold and being capable of detecting movement less than 5 millimeters, and the first determination time being larger than the second determination time; and
a controller configured to generate a passenger presence indication based upon the passenger presence data from radar detectors having overlapping fields of view.

15. The passenger presence detection system of claim 14 wherein the controller is configured to generate the passenger presence indication based upon a voting algorithm applied to the passenger presence data from the radar detectors having overlapping fields of view.

16. The passenger presence detection system of claim 14 wherein the controller is configured to generate a map of the plurality of rows of passenger seats and any passengers therein based upon the passenger presence data.

17. The passenger presence detection system of claim 14 wherein the bus has a passenger access door; and comprising a passenger access door sensor arrangement; and wherein the controller is configured to generate the passenger presence indication further based upon the passenger access door sensor arrangement.

18. The passenger presence detection system of claim 14 comprising a bus position determining device; and wherein the controller is configured to cooperate with the bus position determining device to provide a bus position indication.

19. The passenger presence detection system of claim 14 comprising a wireless transceiver; and wherein the controller is configured to cooperate with the wireless transceiver to provide the passenger presence indication to a remote device.

20. The passenger presence detection system of claim 14 wherein the bus comprises a driver position; and comprising a driver interface at the driver position and coupled to the controller.

21. The passenger presence detection system of claim 14 wherein the bus comprises a communications network therein;
and wherein the plurality of radar detectors and controller communicate via the communications network.

22. The passenger presence detection system of claim 14 wherein the bus has a passenger access aisle extending through the plurality of rows of passenger seats; and wherein the plurality of radar detectors are arranged in spaced relation above the passenger access aisle.

23. A method for passenger presence detection in a bus comprising a plurality of rows of passenger seats, the method comprising:
operating a plurality of radar detectors arranged in spaced relation and directed toward the plurality of rows of passenger seats, each radar detector comprising
at least one radar transmitter,
at least one radar receiver, and
a radar processor cooperating with the at least one radar transmitter and at least one radar receiver to determine passenger presence data based upon a first movement threshold having a first determination time and a second movement threshold having a second determination time, the first movement threshold being smaller than the second movement threshold, the first determination time being larger than the second determination time; and
operating a controller to generate a passenger presence indication based upon the passenger presence data.

24. The method of claim 23 wherein the radar detectors are capable of detecting movement less than 5 millimeters.

25. The method of claim 23 wherein adjacent ones of the plurality of radar detectors are configured to have overlapping fields of view; and wherein operating the controller comprises operating the controller to generate the passenger presence indication based upon passenger presence data from radar detectors having overlapping fields of view.

26. The method of claim 25 wherein operating the controller comprises operating the controller to generate the passenger presence indication based upon a voting algorithm applied to the passenger presence data from the radar detectors having overlapping fields of view.

27. The method of claim 24 wherein operating the controller comprises operating the controller to generate a map of the plurality of rows of passenger seats and any passengers therein based upon the passenger presence data.

28. The method of claim 24 wherein the bus has a passenger access door; and wherein operating the controller comprises operating the controller to generate the passenger presence indication further based upon a passenger access door sensor arrangement.

29. The method of claim 24 wherein operating the controller comprises operating the controller to provide a bus position indication.

30. The method of claim 24 wherein operating the controller comprises operating the controller to provide the passenger presence indication to a remote device via a wireless transceiver.
